(19) United States
(12) Patent Application Publication
(10) Pub. No.: US 2013/0169069 A1
(43) Pub. Date: Jul. 4, 2013

(54) Energized E-Device Transportation Case and Security System Therefore

(71) Applicants: Robert T. Stone, Sunnyvale, CA (US); Ralph C. Francis, Oakland, CA (US)

(72) Inventors: Robert T. Stone, Sunnyvale, CA (US); Ralph C. Francis, Oakland, CA (US)

(21) Appl. No.: 13/665,347

(22) Filed: Oct. 31, 2012

Related U.S. Application Data
(60) Provisional application No. 61/628,566, filed on Nov. 1, 2011.

(51) Int. Cl. H02J 1/00

(52) U.S. Cl. CPC H02J 1/00
USPC 307/150

(57) ABSTRACT

An energized transportation case comprising a housing having an internal region that includes at least one pocket for securely receiving a electronic component, an internal power source, an integral electrical circuitry system for connecting the electronic component to the internal power source, whereby first electrical power is transferred from the internal power source to the electronic component, and a security system that includes power distribution authentication means for secure transmission of external power from an external power source to the internal power source.

### CROSS-REFERENCE TO RELATED APPLICATIONS

This application claims the benefit of U.S. Provisional Application No. 61/628,566, filed Nov. 1, 2011.

### FIELD OF THE INVENTION

The present invention relates to apparatus and methods for storing and/or transporting electronic devices. More particularly, the present invention relates to energized transportation devices, apparatus, systems and methods for storing, transporting and charging electronic devices that include security means.

### BACKGROUND OF THE INVENTION

As is well known in the art, the use of portable electronic devices, such as cellular telephones, personal digital assistants (PDAs), digital music players (MP3s), GPS devices, notebook computers, digital cameras, and the like has increased dramatically over the years. The noted devices, and similar electronic devices, have strict power requirements and often require the use of proprietary batteries and battery chargers to maintain active function.

To maintain active function of the portable electronic devices, many users purchase extra proprietary batteries and associated proprietary chargers. Such chargers typically comprise AC chargers that are adapted to be plugged into an electrical wall socket or an automobile charger.

The electronic devices, and extra batteries and associated chargers are often carried by the user in a carrying or transportation case, e.g., backpack, brief case, etc., thereby diminishing the usable space in the case and increasing the weight that must be carried by the user.

Various carrying cases having integral power sources, e.g. batteries, for charging portable electronic devices have thus been developed. Illustrative are the cases disclosed in U.S. Pub. Nos. 2006/0012331 A1 and 2005/0140331 A1.

The case disclosed in Pub. No. 2006/0012331 A1 comprises a multi-pocket bag (or brief case) that includes integral electronic circuitry. The circuitry is connectable to a power source, such as an integral photo-voltaic module, whereby power can be provided to an electronic device. The case can alternatively include a conventional DC battery.

The case disclosed in Pub. No. 2005/0140331 A1 similarly comprises a multi-pocket bag, i.e. a backpack. The backpack includes an internal power source, i.e. battery, and a solar panel assembly that is affixed to the exterior of the bag. The solar panel assembly includes at least one solar panel that charges the internal battery and provides power to an electronic device.

There are several drawbacks and disadvantages associated with the noted cases, as well as all known cases, which are adapted to secure and charge portable electronic devices. Among the disadvantages are the size and weight of the internal batteries (and solar panels) that are employed to power and charge the contained electronic devices.

A further drawback and disadvantage associated with the noted cases, as well as all known cases that are adapted to secure and charge portable electronic devices via an internal power source, is that the cases do not include any security means; particularly, security means adapted to (i) alert the case owner/user of unauthorized movement of the case, and/or (ii) unauthorized relocation of the bag outside a defined perimeter, and/or (iii) restrict charging of the internal power source without authentication.

It would thus be desirable to provide an energized transportation case that is adapted to secure and charge portable electronic devices via a lightweight internal power source and includes security means adapted to (i) alert the case owner/user of unauthorized movement of the case, and/or (ii) unauthorized relocation of the case outside a defined perimeter, and/or (iii) restrict charging of the internal power source without authentication.

It is therefore an object of the present invention to provide an energized transportation case that is adapted to secure, transport and charge portable electronic devices that overcomes the drawbacks and disadvantages associated with conventional electronic device transportation cases.

It is another object of the present invention to provide an energized transportation case that is adapted to secure, transport and charge portable electronic devices via a lightweight internal power source.

It is another object of the present invention to provide an energized transportation case that is adapted to charge portable electronic devices contained therein via integral energized fabric.

It is another object of the present invention to provide an energized transportation case that includes security means having power source charging authentication means.

It is another object of the present invention to provide an energized transportation case that includes an integral security system having proximity sensing means.

It is another object of the present invention to provide an energized transportation case that includes an integral security system having motion sensing means.

### SUMMARY OF THE INVENTION

In accordance with the above objects and those that will be mentioned and will become apparent below, the energized transportation case, in accordance with one embodiment of the invention comprises (i) a housing having an internal region, the housing including an integral power source having a weight no greater than 3 oz., the housing internal region including at least one pocket for securely receiving a first electronic component, and (ii) an integral electrical circuitry system for connecting the first electronic component to the power source and thereby transferring electrical power from the power source to the first electronic component.

In one embodiment of the invention, the transportation case comprises a backpack.

In a preferred embodiment, the power source has a weight in the range of approximately 1-3 oz.

In some embodiments of the invention, the electrical circuitry system includes a power distribution station for connecting the first electronic component to the power source.

In some embodiments of the invention, the power source comprises energized fabric.

In some embodiments of the invention, the transportation case includes means for transferring external power from an external power source to said case power source.

In another embodiment of the invention, the energized transportation case comprises (i) a housing having an internal region, the housing including an integral power source having a weight no greater than 3 oz., the housing internal region including at least one pocket for securely receiving a first electronic component, and (ii) at least one conductive panel having an integral electrical circuitry system for connecting the first electronic component to the power source and thereby transferring electrical power from the power source to the first electronic component.

In another embodiment of the invention, the energized transportation case comprises (i) a housing having an internal region, the internal region including at least one pocket for securely receiving a electronic component, (ii) an internal power source, (iii) an integral electrical circuitry system for connecting the electronic component to the internal power source and thereby transferring first electrical power from the internal power source to the electronic component, and (iv) a security system in communication with the electrical circuitry system, the security system having power distribution authentication means for secure transmission of external power from an external power source to the internal power source.

In some embodiments of the invention, the electrical circuitry system includes a power distribution station for connecting the electronic component to the internal power source.

In some embodiments of the invention, the internal power source has a weight in the range of approximately 1-3 oz.

In some embodiments of the invention, the case comprises a backpack.

In some embodiments of the invention, the power distribution authentication means includes a charging authentication system and protocol that controls the external power transfer to the internal power source from the external power source.

In some embodiments of the invention, the security system includes a first portable security sensor and proximity sensing means for detecting a first distance from a first case position to a first portable security sensor position, i.e. a security zone.

In some embodiments of the invention, the proximity sensing means transmits a first alarm signal to a first alarm device when the first distance from the first case position to the first sensor position exceeds a first security zone distance.

In some embodiments of the invention, the first alarm device is programmed to generate a first alarm signal indicating that the case has moved beyond the first security zone distance.

In some embodiments of the invention, the first alarm device comprises a smart phone.

In some embodiments of the invention, the security system includes motion sensing means for detecting unauthorized motion of said case.

In some embodiments of the invention, the energized transportation case further includes control means for controlling case functions, such as electronic device charging parameters.

In another embodiment of the invention, the energized transportation case comprises (i) a housing having an internal region, the housing including an integral power source having a weight no greater than 3 oz., the housing internal region including at least one pocket for securely receiving a first electronic component, (ii) energy harvesting means for obtaining and transferring external power to the power source, and (iii) an integral electrical circuitry system for connecting the first electronic component to the power source and thereby transferring electrical power from the power source to the first electronic component.

In some embodiments of the invention, the electrical circuitry system includes a power distribution station for connecting the first electronic component to the power source.

In some embodiments of the invention, the energy harvesting means comprises a photovoltaic energy harvesting system having at least one solar panel.

In some embodiments of the invention, the solar panel comprises a composite fabric having at least one solar cell printed thereon.

In some embodiments of the invention, the energy harvesting means comprises a piezoelectric energy harvesting system.

In some embodiments of the invention, the energy harvesting means comprises a thermoelectric energy harvesting system.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is an illustration of a conventional backpack;

FIGS. 2 and 3 are perspective views of garments that can comprise an energized transportation case of the invention;

FIG. 4 is a perspective view of one embodiment of an energized transportation case, according to the invention;

FIG. 5 is a schematic illustration showing one embodiment of energized transportation case components or sub-systems, according to the invention;

FIG. 6 is a schematic illustration of the energized transportation case shown in FIG. 4 having the case sub-systems shown in FIG. 5 associated therewith, according to the invention;

FIG. 7A is a top plan view of one embodiment of an energized transportation case security module, according to the invention;

FIG. 7B is a top plan view of another embodiment of an energized transportation case security module, according to the invention;

FIG. 8 is a front plan view of one embodiment of an energized transportation case power distribution station, according to the invention;

FIG. 9 is a perspective view of one embodiment of a power connector or cable, according to the invention;

FIG. 10 is one embodiment of an AC adapter for the power connector shown in FIG. 9, according to the invention;

FIG. 11 is a perspective view of one embodiment of an energized transportation case having a conductive fabric rear panel, according to the invention; and

FIG. 12 is a perspective view of one embodiment of an energized transportation case having a printed solar cell associated therewith, according to the invention.

### DETAILED DESCRIPTION OF THE PREFERRED EMBODIMENT

Before describing the present invention in detail, it is to be understood that this invention is not limited to particularly exemplified apparatus, systems, structures or methods as such may, of course, vary. Thus, although a number of apparatus, systems and methods similar or equivalent to those described herein can be used in the practice of the present invention, the preferred apparatus, systems, structures and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise. Thus, for example, reference to “an electronic device” includes two or more such devices and the like.

### DEFINITIONS

The term “case”, as used herein, means and includes a bag, package, backpack, handbag, messenger bag, bike saddle bag, brief case or any apparatus in or to which one or more electronic devices can be positioned or retained.

The term “power source”, as used herein, means and includes any source of power that can be employed to power or charge an electronic device, including, without limitation, a battery, including, without limitation, lithium-ion batteries, nickel based batteries, such as, metal hydride (NiMH), nickel-cadmium (NiCd), and lithium-polymer batteries and the like, and removable battery cells, such as AA or D sized rechargeable batteries, solar panels and associated systems, and photovoltaic modules.

The term “energized”, as used herein in connection with a transportation case, means a case having an independent power or energy means, such as an aforementioned “power source”.

The following disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

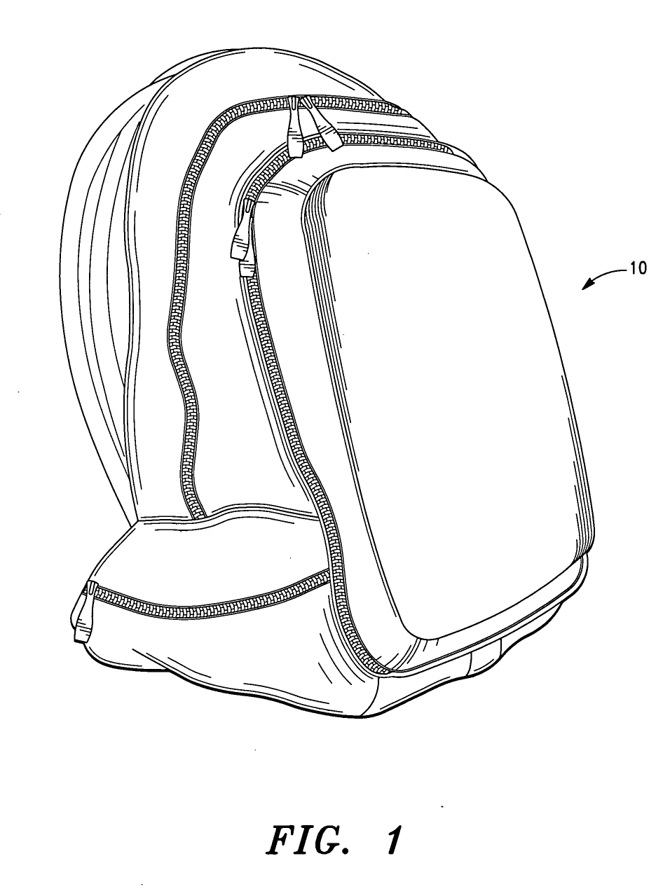

Before describing the present invention in detail, it is to be understood that, although the structures, systems and methods of the invention are illustrated and described in connection with a backpack, such as backpack 10 shown in FIG. 1, the structures, systems and methods of the invention are not limited to a backpack. According to the invention, the structures, systems and methods of the invention can be employed with or on any case or bag or garment that is adapted to position or contain an electronic device, including, without limitation, computer cases, tablet-computer cases, camera bags, messenger bags, briefcases or bags, electronic reader cases, CD player cases, cell phone cases, MP3 cases, GPS cases and/or PDA cases.

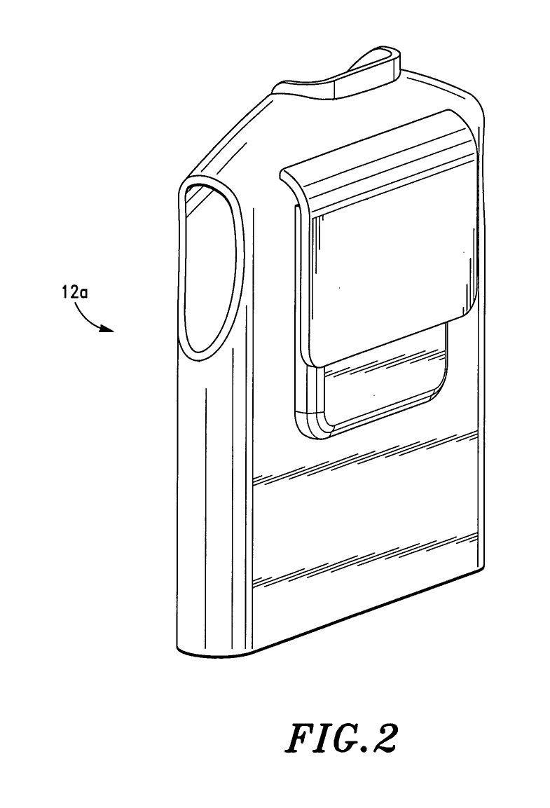

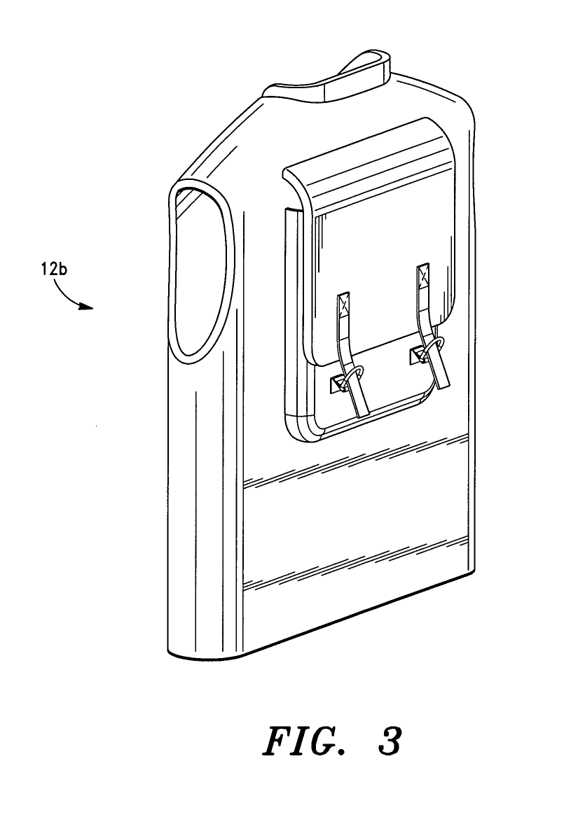

The structures, systems and methods of the invention can also be employed with or incorporated into the wearable garments, i.e. vests, 12a, 12b shown in FIGS. 2 and 3, respectively, and described in detail in U.S. application Ser. No. 12/661,781.

As will readily be appreciated by one having ordinary skill in the art, the present invention substantially reduces or eliminates the disadvantages and drawbacks associated with conventional cases that are adapted to transport and/or charge portable electronic devices.

As stated above, in some embodiments of the invention, the energized transportation case includes at least one independent power source and circuitry means for connecting an electronic device to the power source. In some embodiments of the invention, the case also includes processing means (or processor), a power distribution station, and means for transmitting power from an external power source to the case power source.

As also stated above, in some embodiments of the invention, the case includes a security system in communication with the electrical circuitry system, the security system having power distribution authentication means for secure transmission of external power from an external power source to the internal power source.

In some embodiments of the invention, the security system includes proximity sensing means for detecting a first distance from a first case position to a first portable security sensor position, i.e. a security zone.

In some embodiments of the invention, the security system includes motion sensing means for detecting unauthorized motion of said case.

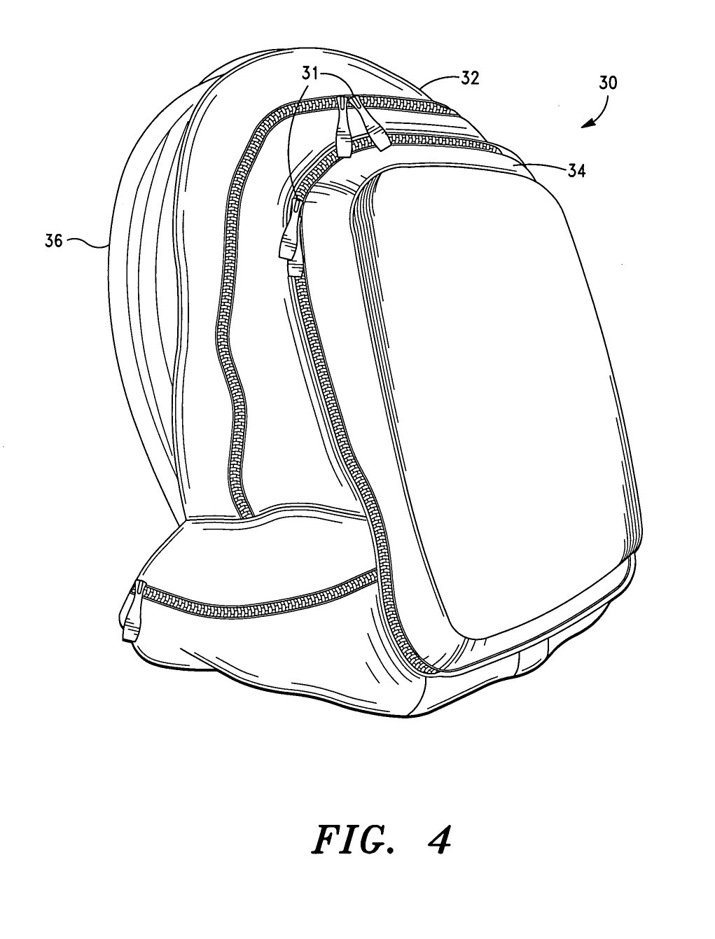

Referring now to FIG. 4, there is shown one embodiment of an energized transportation case 30 of the invention. As illustrated in FIG. 4, the transportation case 30, i.e. backpack, includes an outer body 32, including a rear panel 34, and at least one carrying (or shoulder) strap 36.

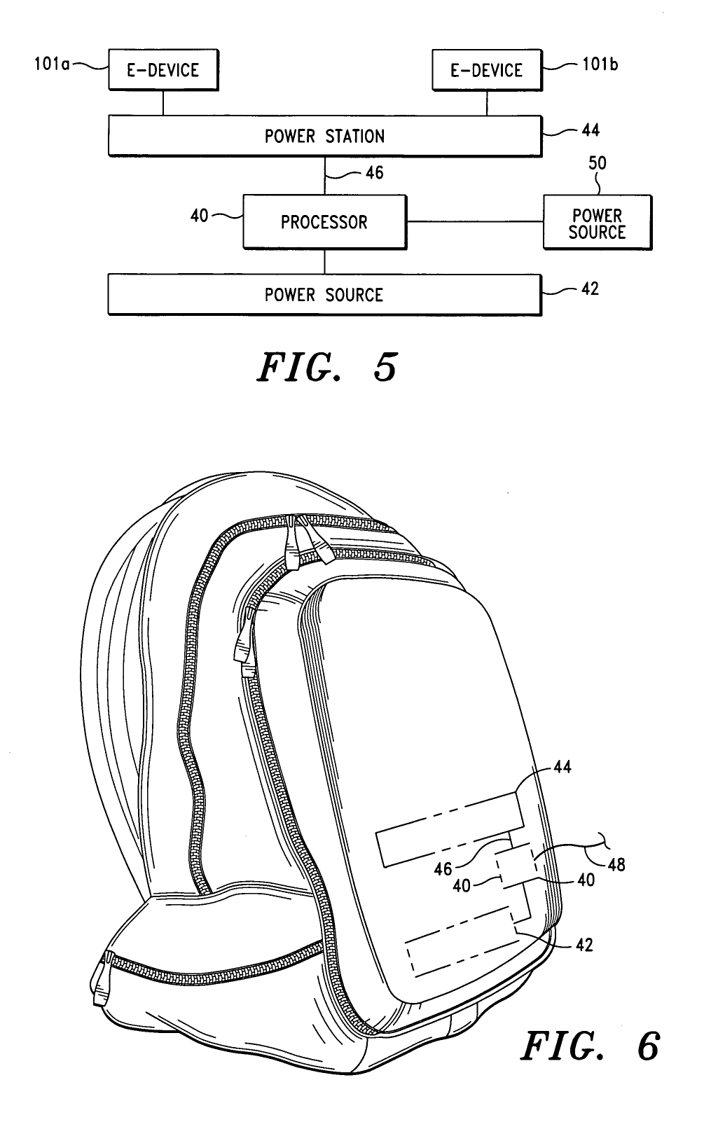

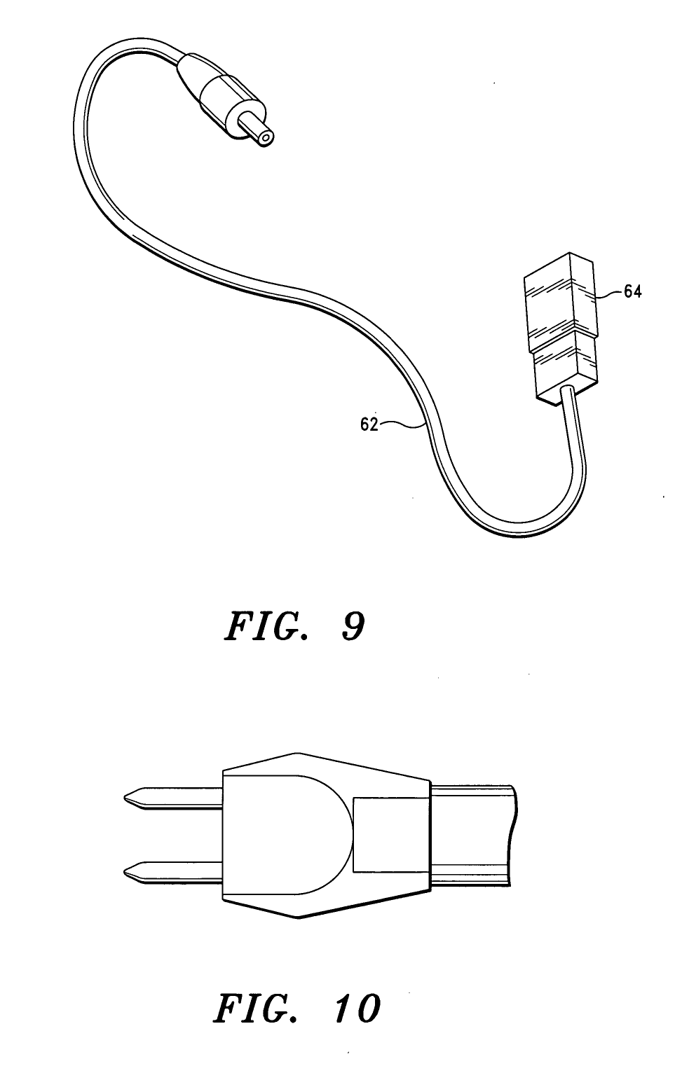

As illustrated in FIGS. 5 and 6, and discussed in detail below, the energized transportation case 30 includes a processor 40, at least one power source 42, a power distribution station 44 that is adapted to operatively receive at least one, preferably, at least two electronic devices 100a, 100b, and circuitry means 46, including at least one power connector 48 (see also power connector 62 in FIG. 9) for transmitting power to the power source 42 from an external power source 50, such as an AC wall socket or computer USB port.

In some embodiments of the invention, the power connector 48 accordingly includes an AC plug disposed one end thereof. In some embodiments, the power connector 48 has USB connector disposed on one end thereof.

According to the invention, the power source 42 can comprise various batteries, including, without limitation, nickel based batteries, such as, metal hydride (NiMH), nickel-cadmium (NiCd), and lithium-polymer batteries and the like. The power source 42 can also comprise removable battery cells, such as AA or D sized rechargeable batteries.

As discussed in detail below, in a preferred embodiment of the invention, the power source 42 comprises a thin, light-weight battery.

In some embodiments of the invention, the processor 40 is adapted to perform at least one of the following functions: (i) regulate power transmitted to and/or emanating from the power source 40, (ii) control power transmitted to the power station 44, and (iii) monitor and control charging time of an electronic device operatively connected to the power station.

In some embodiments of the invention, the power source regulation includes monitoring and controlling voltage and/or current levels, and power source temperature.

As indicated above, in some embodiments of the invention, the energized case includes a security system having a power source charging authentication system, proximity sensing system and motion sensing system. Each of the noted systems is described in detail below.

In some embodiments of the invention, the processor 40 is further adapted to perform at least one of the following additional security functions: (i) control initiation of power source and/or electronic device charging in cooperation with the authentication system and protocol, (ii) monitor the distance from a portable security sensor, which, preferably can be easily carried by a user/owner to the case in cooperation with the proximity sensing system, and transmit a proximity alarm signal to an alarm device to alert the owner that the security sensor and, hence, owner and case are outside a defined distance, i.e. security zone, and (iii) detect unauthorized motion of the case in cooperation with the motion sensing system and transmit an unauthorized motion signal to the alarm device to alert the owner of unauthorized motion of the case, e.g., theft in progress.

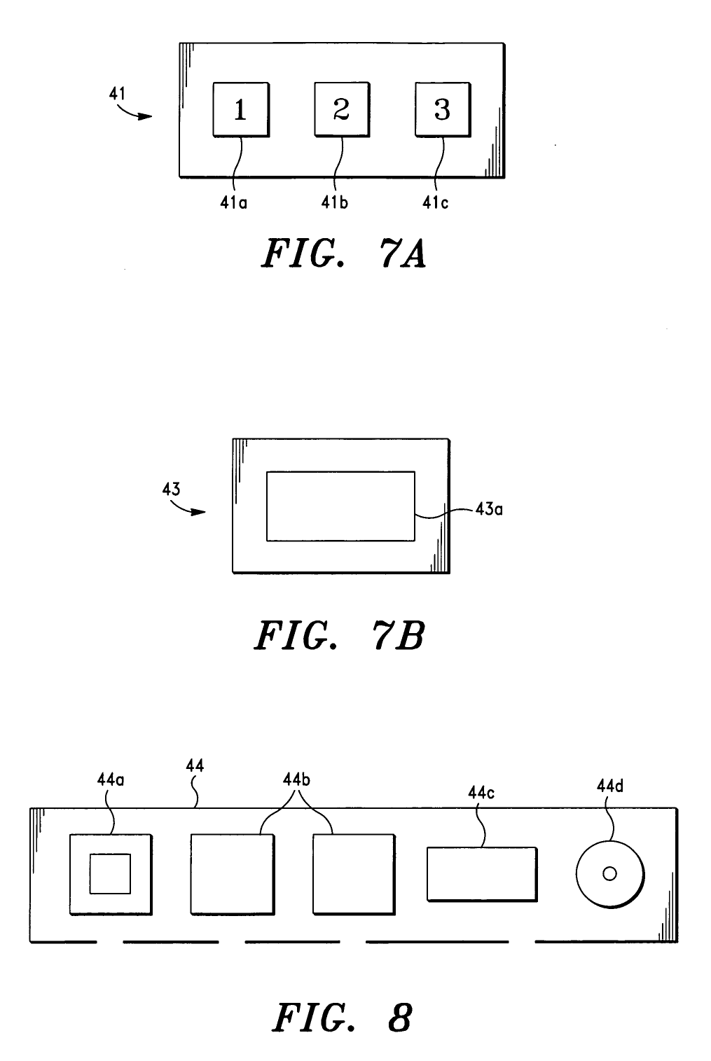

In some embodiments of the invention, the charging authentication protocol requires entry of a security code on a case security module, such as module 41 shown in FIG. 7A, to allow the case power source 42 to be charged. According to the invention, the security code can comprise a numeric code that can be entered via numeric keys 41a-41c or an alpha code.

In some embodiments of the invention, the security module comprises a fingerprint identification module, such as module 43 shown in FIG. 7B.

In some embodiments of the invention, an authenticated link between the power source 42 and a power connector, such as connector 62 (see FIG. 9), is required to charge the power source 42. In some embodiments, the authentication link is provided by a digitally encoded authentication module.

In the noted embodiments, the power connector preferably includes a near-field communication module (RF) or a wired digital interface. According to the invention, to charge the power source 42 the power connector must be in digital communication with the cooperating (or associated) digitally encoded authentication module.

To facilitate charging of the power source 42 when the “secure” power connector is unavailable, in some embodiments, the authentication module or connector includes means for entering a password to allowing charging the power source 42 with a non-secure connector.

According to the invention, the authentication system and protocol can also be employed directly in or with a portable electronic device, such as a cell phone or PDA, and associated charging device.

In some embodiments of the invention, the transportation case includes a proximity sensing system that is adapted to detect when the case is outside a defined pre-set parameter (or zone). In some embodiments of the invention, the sensing system includes a RF proximity module and associated portable security sensor that can be carried by an owner, e.g., in the owner's pocket. In some embodiments, the RF proximity module continuously or intermittently transmits distance signals (representing the distance of the RF proximity module and, hence, case from the security sensor) to the portable sensor and/or processor 40.

According to the invention, when a signal is transmitted to the portable sensor and/or processor 40 by the RF proximity module indicating that the distance between the module and sensor exceeds a pre-set or defined distance, i.e. security zone, the module or processor 40 transmits a proximity alarm signal to an alarm device to alert the owner that the owner and case are outside the security zone.

According to the invention, the security sensor can comprise or be integrated into a separate portable electronic device, such as a cell phone, PDA or iPad, whereby an alarm (audio and/or visual) can be provided directly by the portable device to alert the owner that the case and portable electronic device, e.g. cell phone, are outside the security zone.

In some embodiments of the invention, the transportation case includes a motion sensing system that is similarly adapted to cooperate with the processor 40 and detect unauthorized motion of the case. In some embodiments of the invention, the motion sensing system includes at least one accelerometer and associated portable security sensor that can similarly be carried by an owner, e.g., in the owner's pocket. As will readily be appreciated by one having ordinary skill in the art, the portable security sensor can be adapted to receive the aforementioned proximity sensing signals, as well as motion signals from the accelerometer.

In a preferred embodiment, the accelerometer monitors motion of the case and, when armed, transmits an unauthorized motion signal to the processor 40 (and/or portable security sensor) when such motion is detected. When an unauthorized motion signal is transmitted to the sensor or processor 40, the sensor or processor 40 transmits an unauthorized motion alarm signal to the alarm device to alert the owner of the unauthorized movement of the case.

According to the invention, the proximity and motion sensing systems can also be employed directly in or with a portable electronic device and a separate security sensor.

For devices that have wider range communications capability, such as smart phones, tablet computers, or WI-FI equipped laptop computers, the devices can be adapted to automatically report the movement or unauthorized use via either telephony or WI-FI communications.

In some embodiments of the invention, the case circuitry means 46 further includes a GPS (global positioning system) module that is adapted to provide case location data.

In some embodiments of the invention, the circuitry means 46 further includes a wireless communications module, such as, without limitation, Bluetooth™, Wifi, WLAN, near field communication (NFC) modules and systems. In some embodiments, the wireless communication module is adapted to perform at least one of the following functions: (i) remote measurement of the power source energy, (ii) monitor charging of power source 42, (iii) turn the power source on and off, and (iv) transfer navigation and position data.

In some embodiments of the invention, the energized transportation case (or backpack) 30 further includes at least first and second internal pockets that are adapted to receive and maintain the processor 40 and power source 42, and at least a third internal pocket that is adapted to receive an electronic device, such as a cell phone, or tablet computer, therein. Preferably, the energized transportation case 30 includes a plurality of internal and/or external pockets that are adapted to receive several various sized electronic devices.

To dissipate heat emanating from the power source 42, in some embodiments of the invention, in some embodiments, the energized transportation case 30 includes an internal pocket constructed of a vented and/or heat dissipating material that facilitates the transfer of heat from within the pocket and, hence, case to the surroundings.

According to the invention, the transportation case pockets can also include closure means, such a Velcro arrangement or one or more zipper assemblies 31, such as shown in FIG. 4.

According to the invention, various means can be employed to connect an electronic device to the power source (or battery) 42. Thus, in some embodiments, the circuitry means 46 includes a universal connector that is adapted to facilitate communication by and between a coupled electronic device and the power source 42.

As stated above, in a preferred embodiment of the invention, the energized transportation case 30 includes a power distribution station 44. In a preferred embodiment, the power distribution station 44 is securely disposed on (or in) an internal panel.

Referring now to FIG. 8, the power distribution station 44 preferably includes an on/off switch or button 44a, at least one, preferably, two power receptacles or connections 44b, a power level indicator 44c, and a power input 44d that is adapted to receive a power connector, such as power connector 62 shown in FIG. 9.

In some embodiments of the invention, the power distribution station 44 connections include at least one USB connection, at least one power-over-ethernet connection, at least one AC input and at least one AC output.

As stated above, in some embodiments of the invention, the power connector has an AC plug disposed one end thereof. As illustrated in FIG. 9, in some embodiments, the power connector 62 has USB connector 64 disposed on one end thereof. In some embodiments, an AC adapter 66, which is adapted to engage the USB connector 64 to facilitate connecting to an AC wall socket, is provided (see FIG. 10).

In some embodiments of the invention, the transportation case circuitry means 46 is secured to or covered by the case material (or fabric) to reduce the risk of snagging or breaking a system wire.

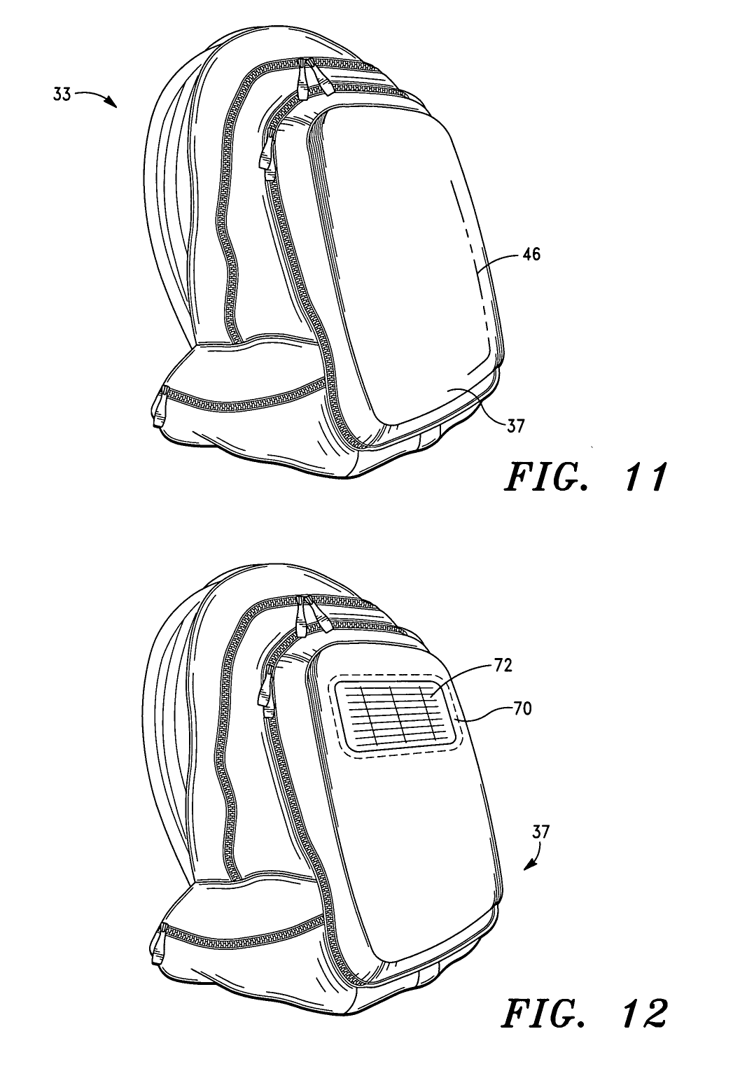

In some embodiments of the invention, the energized transportation case 33 includes at least one panel, preferably, a rear panel that comprises a conductive fabric, such as the electrically conductive composite yarn disclosed in U.S. Pat. Nos. 7,926,254 and 7,504,127, which are incorporated by reference herein. Referring now to FIG. 11, in this embodiment, the circuitry means 46 is incorporated in the electrically conductive rear panel 37.

In some embodiments of the invention, the power source 42 comprises a self-contained energized fabric, i.e. an imbedded multi-chemistry power source. In some embodiments, the imbedded power source comprises a malleable material that has energy storage capacity and capability, allowing for energy storage to be spread across an ultra thin, fabric-like, semi-hard surface.

In some embodiments, the energized fabric comprises a battery electrode fabric that includes a plurality of nanotubes containing at least 80% active material, such as lithium-iron-phosphate powders.

In some embodiments of the invention, the power source 42 comprises a printed battery. In the noted embodiment, the active battery components are preferably screen printed on an internal or external panel of the bag.

According to the invention, the energized fabric and printed battery have a substantially reduced weight compared to a standard battery. In a preferred embodiment, the weight of the noted power sources is less than 1-3 oz.

In some embodiments of the invention, the energized transportation case 30 includes means for harvesting energy for charging the power source 42 and/or powering an electronic device. According to the invention, the energy harvesting means can comprise various means, including, without limitation, photovoltaic, piezoelectric, pyroelectric, thermoelectric, radio frequency, ultrasound, and electrostatic energy harvesting means.

Thus, in some embodiments of the invention, the means for harvesting energy for charging the power source 42 comprises photovoltaic energy harvesting. As is well known in the art, photovoltaic energy harvesting provides virtually inexhaustible sources of power with little or no adverse environmental effects.

To facilitate photovoltaic energy harvesting, in some embodiments of the invention, the energized transportation case 37 includes a solar panel assembly 70 (see FIG. 12). In a preferred embodiment, the solar panel assembly 70 is operatively coupled to the case circuitry means 46.

In some embodiments of the invention, the solar panel assembly 70 comprises a composite fabric having at least one solar cell 72 printed thereon. According to the invention, the composite fabric solar panel can comprise an outer panel of the energized transportation case 30 or be attached thereto.

In some embodiment, the solar cell 72 comprises a dye sensitized solar cell. As is well known in the art, in such cells, the dyes absorb light much like chlorophyll does in plants. Electrons released on impact escape to the layer of TiO2 and from there diffuse, through the electrolyte. The dye can be tuned to the visible spectrum, whereby much higher power can be produced. For example, at 200 lux, dye sensitized solar cells can provide over 15 micro watts per cm².

In some embodiments of the invention, the means for harvesting energy for charging the power source comprises piezoelectric energy harvesting, i.e. energy harvesting that employs a piezoelectric effect to convert mechanical strain into electric current or voltage. This strain can come from many different sources, including human motion, low-frequency seismic vibrations, and acoustic noise. Since the piezoelectric effect typically operates in AC, time-varying inputs at mechanical resonance are required for efficient conversion.

In some piezoelectric energy harvesting devices, micro-hydraulic energy is employed. In these devices, the flow of pressurized hydraulic fluid drives a reciprocating piston supported by three piezoelectric elements that convert the pressure fluctuations into an alternating current.

Nanobrushes developed by Dr. Zhong Lin Wang are another example of a piezoelectric energy harvester. As set forth in Xu, et. A., “Self Powered Nanowire Devices”, Nature Nanotechnology, vol. 5, pp. 366-373 (2010), such devices can readily be integrated into fabric or clothing.

In some embodiments of the invention, the means for harvesting energy for charging the power source comprises pyroelectric energy harvesting, i.e. energy harvesting that employs a pyroelectric effect that converts a temperature change into electric current or voltage.

In some embodiments of the invention, the means for harvesting energy for charging the power source comprises thermoelectric energy harvesting, i.e. energy harvesting that employs a thermoelectric effect that converts a temperature change into electric current or voltage. At the heart of the thermoelectric effect is the fact that a temperature gradient in a conducting material results in heat flow; this results in the diffusion of charge carriers. The flow of charge carriers between the hot and cold regions in turn creates a voltage difference.

As is well known in the art, ideal thermoelectric materials have a high Seebeck coefficient, high electrical conductivity, and low thermal conductivity. Low thermal conductivity is necessary to maintain a high thermal gradient at the junction.

As is also well known in the art, standard thermoelectric modules manufactured today consist of P- and N-doped bismuth-telluride semiconductors sandwiched between two metallized ceramic plates. The ceramic plates add rigidity and electrical insulation to the system. The semiconductors are coupled electrically in series and thermally in parallel.

Advantages associated with thermoelectrics include:
No moving parts allow continuous operation for many years. Tellurex Corporation (a thermoelectric production company) claims that thermoelectrics are capable of over 100,000 hours of steady state operation.
Thermoelectrics contain no materials that must be replenished.
Heating and cooling can be reversed.

In some embodiments of the invention, the means for harvesting energy for charging the power source comprises electrostatic energy harvesting. As is well known in the art, electrostatic energy harvesting is based on the changing capacitance of vibration-dependent varactors. Vibrations separate the plates of an initially charged varactor (variable capacitor), and mechanical energy is converted into electrical energy.

An example of an electrostatic energy harvester with embedded energy storage is the M2E Power Kinetic Battery. Another example is CSIRO's Flexible Integrated Energy Device (FIELD). Yet another example is the Tremont Electric nPower PEG.

Without departing from the spirit and scope of this invention, one of ordinary skill can make various changes and modifications to the invention to adapt it to various usages and conditions. As such, these changes and modifications are properly, equitably, and intended to be, within the full range of equivalence of the invention.

What is claimed is:

1. An energized transportation case, comprising:
a housing having an internal region, said internal region including at least one pocket for securely receiving a electronic component;
an internal power source;
an integral electrical circuitry system for connecting said electronic component to said internal power source, whereby first electrical power is transferred from said internal power source to said electronic component; and
a security system in communication with said electrical circuitry system, said security system including power distribution authentication means for secure transmission of external power from an external power source to said internal power source.

2. The transportation case of claim 1, wherein said power distribution authentication means includes a charging authentication system and protocol, said charging authentication system and protocol being programmed to control said external power transfer to said internal power source.

3. The transportation case of claim 1, wherein said security system includes a first portable security sensor and proximity sensing means for detecting a first distance from a first case position to a first portable security sensor position.

4. The transportation case of claim 3, wherein said proximity sensing means is programmed and configured to transmit a first alarm signal to a first alarm device when said first distance from the first case position to said first sensor position exceeds a first security zone distance.

5. The transportation case of claim 4, wherein said first alarm device is programmed to generate a second alarm signal indicating that the transportation case moved beyond said first security zone distance.

6. The transportation case of claim 5, wherein said second alarm signal comprises an audible signal.

7. The transportation case of claim 5, wherein said first alarm device comprises a smart phone.

8. The transportation case of claim 1, wherein said security system includes motion sensing means for detecting unauthorized motion of the transportation case.
